(19) United States
(12) Patent Application Publication
(10) Pub. No.: US 2012/0087039 A1
(43) Pub. Date: Apr. 12, 2012

(54) MAGNETIC RECORDING MEDIUM, METHOD OF MANUFACTURING THE SAME, AND MAGNETIC RECORDING/REPRODUCTION APPARATUS

(75) Inventors: Takeshi Iwasaki, Inagi-shi (JP); Kaori Kimura, Yokohama-shi (JP); Yoshiyuki Kamata, Tokyo (JP); Tsuyoshi Onitsuka, Hino-shi (JP); Masatoshi Sakurai, Tokyo (JP)

(73) Assignee: KABUSHIKI KAISHA TOSHIBA, Tokyo (JP)

(21) Appl. No.: 13/164,601

(22) Filed: Jun. 20, 2011

(30) Foreign Application Priority Data
Oct. 8, 2010 (JP) 2010-228778

(51) Int. Cl. G11B 17/02; G11B 5/65; G11B 5/84; G11B 5/64

(52) U.S. Cl. 360/99.08; 428/800; 427/526; G9B/17.002

(57) ABSTRACT

According to one embodiment, a magnetic recording medium includes a substrate, and a magnetic recording layer formed on the substrate. The magnetic recording layer includes recording portions having patterns regularly arranged in an longitudinal direction and containing cobalt and platinum, and non recording portions formed between the recording portions and containing boron and at least one light rare earth metal selected from the group consisting of yttrium, lanthanum, and cerium.

### CROSS-REFERENCE TO RELATED APPLICATIONS

This application is based upon and claims the benefit of priority from Japanese Patent Application No. 2010-228778, filed Oct. 8, 2010; the entire contents of which are incorporated herein by reference.

### FIELD

Embodiments described herein relate generally to a magnetic recording medium, a method of manufacturing the same, and a magnetic recording/reproduction apparatus.

### BACKGROUND

The need for a high-capacity hard disk drive (HDD) is increasing yearly. A presently prevalent magnetic recording medium has an arrangement in which each layer forming the recording medium is evenly formed on the entire substrate surface. When achieving a recording capacity exceeding 500 Gb/in², however, adjacent data signals are too close to each other. When recording or reproducing the data signals, therefore, a phenomenon in which nearby data not to be recorded nor reproduced is read out or written occurs.

Accordingly, patterned media have recently extensively been studied as techniques of further increasing the recording density. The patterned medium has the feature that a magnetic film is processed into predetermined patterns in advance, and information is recorded or reproduced by a recording/reproduction head in accordance with the patterns. As the forms of the processed patterns, a discrete track medium (DTM) in which only servo information and recording tracks are processed and data is recorded in the circumferential direction by the conventional method and a so-called bit patterned medium (BPM) in which not only servo information is processed but also bit patterns are processed in the circumferential direction have been examined.

Since servo information is preformed on the discrete track medium (DTM) and bit patterned medium (BPM) as described above, it is possible to shorten the conventionally necessary time for magnetically recording the servo information, and reduce the apparatus cost. Also, no magnetic film exists between tracks or magnetization reversal units (bits), so no noise is generated from the tracks or bits. This makes it possible to improve the signal quality (signal/noise ratio: SNR), and manufacture a high-density magnetic recording medium and magnetic recording apparatus.

In the DTM and BPM, however, a magnetic film is processed into fine patterns, so the film may be damaged during the processing. As an example, the oxidation of a magnetic element such as Co may deteriorate the magnetic characteristics of the magnetic film, thereby degrading the recording/reproduction characteristics of the medium.

Accordingly, demands have arisen for a simple process that can be implemented while maintaining the recording/reproduction characteristics.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view of a section showing a magnetic recording medium according to an embodiment;

FIG. 2 is an exemplary view of a flowchart showing some steps of a method of manufacturing the magnetic recording medium according to the embodiment;

FIG. 3 is a partially exploded perspective view of a magnetic recording/reproduction apparatus according to the embodiment;

FIGS. 4A, 4B, 4C, 4D, 4E, 4F, 4G, 4H, 4I, 4J, and 4K are exemplary views of the process of the manufacturing method of the magnetic recording medium according to the embodiment;

FIG. 5 is a front view showing an embodiment of three-dimensional patterns in which recording tracks and information for positioning a recording/reproduction head are recorded; and

FIG. 6 is a front view showing an embodiment of three-dimensional patterns in which recording bits and information for positioning a recording/reproduction head are recorded.

### DETAILED DESCRIPTION

Various embodiments will be described hereinafter with reference to the accompanying drawings.

In general, according to one embodiment, a magnetic recording medium includes a substrate, and a magnetic recording layer formed on the substrate.

The magnetic recording layer includes recording portions having patterns regularly arranged in the longitudinal direction in accordance with recording tracks or recording bits and recording/reproduction head positioning information, and non-recording portions formed between the recording portions.

The recording portions contain cobalt and platinum as main components.

The non-recording portions contain boron and at least one light rare earth metal selected from the group consisting of yttrium, lanthanum, and cerium, in addition to cobalt and platinum contained in the above-mentioned recording portions.

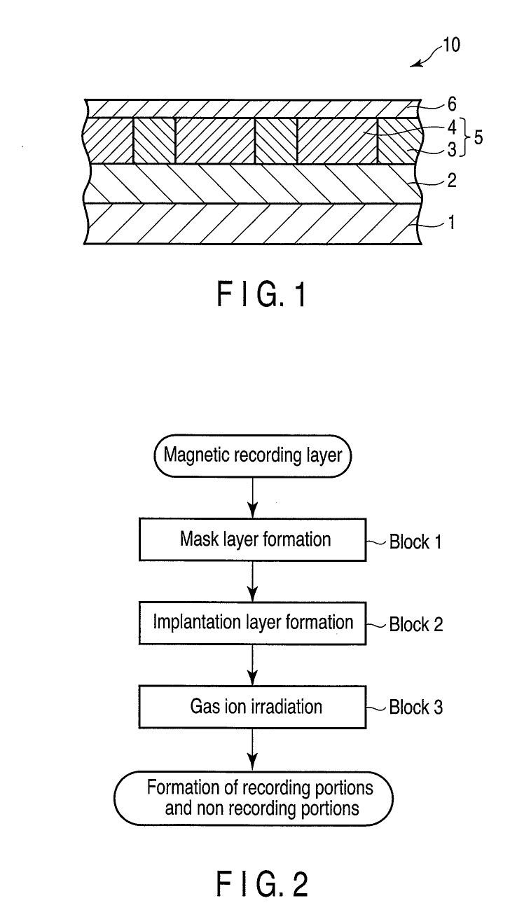

FIG. 1 is a sectional view showing an example of the magnetic recording medium according to the embodiment.

As shown in FIG. 1, this magnetic recording medium includes a substrate 1, an arbitrary underlayer 2 formed on the substrate 1, a magnetic recording layer 5 formed on the underlayer 2 and including recording portions 4 and non-recording portions 3, and a protective layer 6 formed on the magnetic recording layer 5. The recording portions 4 have patterns regularly arranged in the longitudinal direction in accordance with recording tracks or recording bits and recording/reproduction head positioning information, and contain cobalt and platinum. The non-recording portions 3 are formed between the recording portions and contain boron and at least one light rare earth metal selected from the group consisting of yttrium, lanthanum, and cerium, in addition to cobalt and platinum.

The recording portions can also contain boron and at least one light rare earth metal selected from the group consisting of yttrium, lanthanum, and cerium, in addition to cobalt and platinum, to such an extent that the magnetism does not deteriorate. In this case, the content shown by atomic percentage (at %) of the light rare earth metal contained in the non-recording portions can be made higher by 10 at % or more than the content (at %) of the light rare earth metal contained in the recording portions.

Good magnetic recording/reproduction characteristics are obtained when using the magnetic recording medium of the embodiment.

FIG. 2 is a flowchart showing some steps of a method of manufacturing the above-mentioned magnetic recording medium.

In the manufacturing method of the magnetic recording medium according to the embodiment, a magnetic recording medium in which a magnetic recording layer is formed on a substrate is first prepared.

Then, as shown in FIG. 2, a mask layer having regularly arranged patterns is formed on the magnetic recording layer formed on the substrate and containing cobalt and platinum (block 1).

Note that if a protective layer is formed on the magnetic recording layer of the prepared magnetic recording medium, this protective layer can be removed from at least a region where no mask layer is to be formed, when forming the mask layer.

Subsequently, an implantation layer containing at least one light rare earth metal selected from the group consisting of yttrium, lanthanum, and cerium is formed through the mask layer (block 2).

After that, gas ion irradiation is performed on the implantation layer by using an implantation gas (block 3).

In this step, at least one of the implantation layer and implantation gas contains boron.

This gas ion irradiation demagnetizes the magnetic recording layer in the thickness direction in those regions of the magnetic recording layer, which are not covered with the mask layer, thereby forming non-recording portions.

Since the magnetic recording layer is not demagnetized in regions covered with the mask layer, recording portions having regularly arranged patterns are formed.

Thus, the recording portions and the non-recording portions arranged between the recording portions can be formed in the magnetic recording layer.

Note that a protective layer can be formed, as needed, on the magnetic recording layer including the recording portions and non-recording portions.

As the implantation layer, it is possible to use an implantation layer containing boron or an implantation layer not containing boron. When using the implantation layer not containing boron, a gas containing boron is used as the implantation gas.

Examples of the implantation layer containing boron are a layer containing a boride of at least one light rare earth metal selected from the group consisting of yttrium, lanthanum, and cerium, and a multilayered film including this light-rare-earth-metal-containing layer and a boron layer.

When using the implantation layer containing boron, it is possible to use an inert gas such as argon, nitrogen, or helium-nitrogen, as the implantation gas.

When using the layer not containing boron and containing a light rare earth metal as the implantation layer, a boron-containing gas such as B₂H₆ is used as the implantation gas.

A boron-containing gas such as B₂H₆ has a strong corrosion action and is difficult to handle, and this increases the installation cost as well. Therefore, it is preferable to use a combination of the implantation layer containing boron and an inert gas.

When using the method according to the embodiment, boron and at least one light rare earth metal selected from the group consisting of yttrium, lanthanum, and cerium are implanted in the magnetic layer containing cobalt and platinum by the formation of the implantation layer and the gas ion irradiation using the implantation gas. This makes it possible to readily demagnetize non-recording layer regions in the thickness direction of the magnetic recording layer, without inflicting any damage to recording layer regions covered with the mask layer.

This is presumably due to the following effects.

(Solid Solution Effect)

A light rare earth metal boride (light rare earth metal=Y, La, or Ce) can be used when implanting boron and at least one light rare earth metal selected from the group consisting of yttrium, lanthanum, and cerium in the magnetic layer containing cobalt and platinum by the formation of the implantation layer and the gas ion irradiation using the implantation gas. Three effects can be expected from the light rare earth metal boride. The first effect is that the light rare earth metal boride existing in the magnetic layer deactivates the magnetism by largely distorting the crystal lattices. The second effect is that a light rare earth metal separates from boron and forms an alloy together with Co, thereby deactivating the magnetism. The third effect is that boron dissociates and enters between the lattices in the recording layer, thereby deactivating the magnetism.

For example, hexaborides of Y, La, and Ce are known. When one of these rare earth metal hexaborides enters the recording layer and dissociates, six boron atoms can be implanted in the recording layer, so the boron implantation efficiency is high. In addition, a light rare earth metal is chemically active. When a boride dissociates into a light rare earth metal, therefore, the metal often easily diffuses in the crystal to seek for a bonding partner. Boron and a boride have a strong effect of amorphousizing the crystal of a Co-based magnetic recording layer, and also have a function of increasing the light rare earth boride diffusing effect.

(Assisting Effect of Gas)

The use of N₂ gas or HeN₂ gas further promotes the deactivation due to the addition of the magnetism deactivating effect resulting from the gas itself or a nitride formed during the process.

The embodiment can thus achieve good recording/reproduction characteristics.

Also, when using the layer containing a boride of a light rare earth metal, the light rare earth metal and boron are implanted more uniformly than when using the multilayered film of a layer containing the light rare earth metal and a boron layer. This makes it possible to stably demagnetize the non-recording layer, and obtain favorable recording/reproduction characteristics.

Furthermore, a magnetic recording/reproduction apparatus according to the embodiment includes the above-described magnetic recording medium,

a mechanism for supporting and rotating a perpendicular magnetic recording medium,

a magnetic head including an element for recording information on the perpendicular magnetic recording medium and an element for reproducing recorded information, and

a carriage assembly supporting the magnetic head such that it freely moves with respect to the perpendicular magnetic recording medium.

<Substrate>

As the substrate, it is possible to use, e.g., a glass substrate, an Al-based alloy substrate, a ceramic substrate, a carbon substrate, or an Si single-crystal substrate having an oxidized surface. Examples of the glass substrate are amorphous glass and crystallized glass. Examples of the amorphous glass are general-purpose soda lime glass and alumino silicate glass. An example of the crystallized glass is lithium-based crystallized glass. Examples of the ceramic substrate are general-purpose sintered products mainly containing aluminum oxide, aluminum nitride, and silicon nitride, and fiber reinforced products of these sintered products. As the substrate, it is also possible to use a substrate obtained by forming an NiP layer on the surface of any of the metal substrates and non-metal substrates described above by using plating or sputtering.

Although only sputtering is described above as the method of forming a thin film on the substrate, the same effect can be obtained by using, e.g., vacuum deposition or electroplating.

<Soft Magnetic Underlayer>

A soft magnetic underlayer (SUL) horizontally passes a recording magnetic field from a single-pole head for magnetizing the perpendicular magnetic recording layer, and returns the magnetic field toward the magnetic head, i.e., performs a part of the function of the magnetic head. The soft magnetic underlayer has a function of applying an abrupt sufficient perpendicular magnetic field to the magnetic field recording layer, thereby increasing the recording/reproduction efficiency. A material containing Co, Fe, or Ni can be used as the soft magnetic underlayer. As this material, it is possible to use a Co alloy containing Co and at least one of Zr, Hf, Nb, Ta, Ti, and Y. The Co alloy preferably contains 80 at % or more of Co. When the Co alloy like this is deposited by sputtering, an amorphous layer readily forms. The amorphous soft magnetic material has none of magnetocrystalline anisotropy, a crystal defect, and a grain boundary, and hence has very high soft magnetism and can reduce the noise of the medium. Preferable examples of the amorphous soft magnetic material are CoZr-, CoZrNb-, and CoZrTa-based alloys.

Other examples of the soft magnetic underlayer material are FeCo-based alloys such as FeCo and FeCoV, FeNi-based alloys such as FeNi, FeNiMo, FeNiCr, and FeNiSi, FeAl-based alloys, FeSi-based alloys such as FeAl, FeAlSi, FeAlSiCr, FeAlSiTiRu, and FeAlO, FeTa-based alloys such as FeTa, FeTaC, and FeTaN, and FeZr-based alloys such as FeZrN. It is also possible to use a material having a microcrystalline structure or a granular structure in which fine crystal grains are dispersed in a matrix. Examples are FeAlO, FeMgO, FeTaN, and FeZrN containing 60 at % or more of Fe.

Furthermore, in order to prevent spike noise, it is possible to divide the soft magnetic underlayer into a plurality of layers, and insert a 0.5- to 1.5-nm thick nonmagnetic dividing layer, thereby causing antiferromagnetic coupling. In this case, it is possible to use, e.g., Ru, an Ru alloy, Pd, Cu, or Pt.

The soft magnetic layer may also be exchange-coupled with a pinned layer made of a hard magnetic layer having longitudinal anisotropy such as CoCrPt, SmCo, or FePt, or an antiferromagnetic material such as IrMn or PtMn. To control the exchange coupling force, it is possible to stack magnetic films (e.g., Co) or nonmagnetic films (e.g., Pt) on the upper and lower surfaces of the nonmagnetic dividing layer.

An adhesion layer can further be formed below the soft magnetic underlayer in order to improve the adhesion to the substrate. As the material of this adhesion layer, it is possible to use Ti, Ta, W, Cr, Pt, an alloy containing any of these elements, or an oxide or nitride of any of these elements.

<Orientation Control Layer>

An orientation control layer controls the crystal orientation or crystal grain size in an interlayer or the perpendicular magnetic recording layer. As the orientation control layer, it is desirable to use one of an Ni alloy, Pt alloy, Pd alloy, Ta alloy, Cr alloy, Si alloy, or Cu alloy. When using these alloys, it is possible to improve the crystal orientation and decrease the crystal grain size. A predetermined element may also be added in order to increase the matching of the crystal lattice size to that of the underlayer. Examples of an element to be added to decrease the crystal size are B, Mn, Al, Si oxide, and Ti oxide. Examples of an element to be added to increase the matching of the crystal lattice size to that of the underlayer are Ru, Pt, W, Mo, Ta, Nb, and Ti. The film thickness of the orientation control layer is desirably 1 (inclusive) to 10 (inclusive) nm. If the film thickness of the orientation control layer is less than 1 nm, the effect of the orientation control layer becomes insufficient. As a consequence, no grain downsizing effect can be obtained, and the crystal orientation worsens as well. If the film thickness of the orientation control layer exceeds 10 nm, a spacing loss is produced, and the crystal grain size increases. The orientation control layer can also be formed by a plurality of layers instead of a single layer. In this case, the film thickness of the whole orientation control layer is desirably 2 (inclusive) to 15 (inclusive) nm. If the film thickness is less than 2 nm, the effect of the orientation control layer becomes insufficient. If the film thickness of the whole orientation control layer exceeds 15 nm, the spacing loss cannot be ignored any longer, and the recording/reproduction characteristics worsen.

<Interlayer>

An interlayer made of a nonmagnetic material may be formed between the soft magnetic layer and recording layer. The interlayer has two functions, i.e., interrupts the exchange coupling interaction between the soft magnetic underlayer and recording layer, and controls the crystallinity of the recording layer. As the material of the interlayer, it is possible to use Ru, Pt, Pd, W, Ti, Ta, Cr, Si, an alloy containing any of these elements, or an oxide or nitride of any of these elements. It is particularly desirable to use Ru or an Ru alloy. Examples of the Ru alloy are Ru—Cr, Ru—Co, Ru—Mn, Ru—SiO₂, Ru—TiO₂, Ru—TiOₓ, Ru—B, and Ru—C. Among these alloys, Ru or Ru—Cr capable of achieving high crystallinity is desirable. It is also desirable to form a two-layered structure including, e.g., first and second underlayers. In this case, the first underlayer preferably has a relatively high density and high crystallinity. For example, a first underlayer having a high density and high crystallinity can be formed by performing sputtering at a low Ar pressure of 1 Pa or less. The second underlayer preferably has clear crystal grains and a clear grain boundary. For example, a second underlayer having a clear crystal and clear grain boundary can be formed by performing sputtering at a high Ar pressure of 5 Pa or more. The film thickness of the underlayer is desirably 5 (inclusive) to 24 (inclusive) nm, and more desirably, 16 nm or less. If the film thickness of the underlayer is small, the distance between a magnetic head and the soft backing layer decreases. This makes it possible to obtain a steep magnetic flux from the magnetic head, and improve the signal write easiness. If the film thickness of the underlayer is less than 5 nm, the crystal orientation worsens. On the other hand, if the film thickness of the underlayer is 24 nm or more, a spacing loss is produced, and the recording/reproduction characteristics worsen.

<Ferromagnetic Layer>

As the perpendicular magnetic recording layer, it is favorable to use a material mainly containing Co and containing at least Pt. The perpendicular magnetic recording layer may contain Cr or an oxide as needed. Silicon oxide or titanium oxide is particularly favorable as the oxide.

The Pt content in the perpendicular magnetic recording layer is preferably 10 (inclusive) to 25 (inclusive) at %. The above-mentioned range is preferable as the Pt content because a uniaxial magnetocrystalline anisotropy constant (Ku) necessary for the perpendicular magnetic layer is obtained, the crystallinity and orientation of the magnetic grains improve, and as a consequence thermal decay characteristics and recording/reproduction characteristics suited to high-density recording are obtained. If the Pt content exceeds the above range, a layer having the face-centered cubic (fcc) structure is formed in the magnetic grains, and the crystallinity and orientation may deteriorate. If the Pt content is less than the above range, it is often impossible to obtain thermal decay characteristics suitable for high-density recording and a sufficient Ku. The Cr content in the perpendicular magnetic recording layer is preferably 0 (inclusive) to 20 (inclusive) at %, and more preferably, 10 (inclusive) to 16 (inclusive) at %. The above-mentioned ranges is preferable as the Cr content because high magnetization can be maintained without excessively decreasing the Ku of the magnetic grains, and as a consequence recording/reproduction characteristics suited to high-density recording and sufficient thermal decay characteristics are obtained. If the Cr content exceeds the above range, the thermal decay characteristics worsen because the Ku of the magnetic grains decreases, and the crystallinity and orientation of the magnetic grains worsen. Consequently, the recording/reproduction characteristics deteriorate.

The oxide content in the perpendicular magnetic recording layer is preferably 3 (inclusive) to 15 (inclusive) mol %, and more preferably, 5 (inclusive) to 12 (inclusive) mol % with respect to the total amount of Co and Pt. The above-mentioned range is preferable as the oxide content in the perpendicular magnetic recording layer because the oxide deposits around the magnetic grains when the perpendicular magnetic recording layer is formed, so the magnetic grains can be isolated and downsized. If the content of the oxide exceeds the above range, the oxide remains in the magnetic grains and deteriorates the orientation and crystallinity of the magnetic grains. Furthermore, the oxide deposits above and below the magnetic grains. As a consequence, a pillar structure in which the magnetic grains vertically extend through the perpendicular magnetic recording layer is no longer formed. If the content of the oxide is less than the above range, the magnetic grains are insufficiently isolated and downsized. As a result, noise increases in recording and reproduction, and SNR suited to high-density recording cannot be obtained any longer.

The perpendicular magnetic recording layer can contain one or more elements selected from B, Ta, Mo, Cu, Nd, W, Nb, Sm, Tb, Ru, and Re, in addition to Co, Cr, Pt, and the oxide. These elements can promote the downsizing of the magnetic grains, or improve the crystallinity and orientation of the magnetic grains. This makes it possible to obtain recording/reproduction characteristics and thermal decay characteristics more suitable for high-density recording. The total content of the above-mentioned elements is preferably 8 at % or less. If the total content exceeds 8 at %, a phase other than the hexagonal close packed (hcp) phase forms in the magnetic grains, and disturbs the crystallinity and orientation of the magnetic grains. Consequently, it is impossible to obtain recording/reproduction characteristics and thermal decay characteristics suited to high-density recording.

As the perpendicular magnetic recording layer, it is also possible to use any of a CoPt-based alloy, a CoCr-based alloy, a CoPtCr-based alloy, CoPtO, CoPtCrO, CoPtSi, CoPtCrSi, a multilayered structure containing Co and an alloy mainly containing at least one element selected from the group consisting of Pt, Pd, Rh, and Ru, and CoCr/PtCr, CoB/PdB, and CoO/RhO obtained by adding Cr, B, and O to the multilayered structure.

The thickness of the perpendicular magnetic recording layer is preferably 3 to 30 nm, and more preferably, 5 to 15 nm. When the thickness falls within this range, a magnetic recording/reproduction apparatus suited to a high recording density can be manufactured. If the thickness of the perpendicular magnetic recording layer is less than 3 nm, the reproduction output becomes too low, so the noise component often becomes higher than the reproduction output. If the thickness of the perpendicular magnetic recording layer exceeds 30 nm, the reproduction output becomes too high and tends to distort the waveform. The coercive force of the perpendicular magnetic recording layer is preferably 237,000 A/m (3,000 Oe) or more. If the coercive force is less than 237,000 A/m (3,000 Oe), the thermal decay resistance tends to decrease. The perpendicular squareness ratio of the perpendicular magnetic recording layer is preferably 0.8 or more. If the perpendicular squareness ratio is less than 0.8, the thermal decay resistance often decreases.

<Protective Film>

A protective film is formed to prevent the corrosion of the perpendicular magnetic recording layer, and prevent damages to the medium surface when a magnetic head comes in contact with the medium. Examples of the material of the protective film are materials containing C, SiO₂, and ZrO₂. The thickness of the protective film is preferably 1 to 10 nm. This thickness is suitable for high-density recording because the distance between the head and medium can be decreased. Carbon can be classified into sp²-bonded carbon (graphite) and sp³-bonded carbon (diamond). Sp³-bonded carbon is superior in durability and corrosion resistance, but inferior to graphite in surface smoothness because diamond is crystalline. A carbon film is normally formed by sputtering using a graphite target. This method forms amorphous carbon containing both sp²-bonded carbon and sp³-bonded carbon. Amorphous carbon having a high sp³-bonded carbon ratio is called diamond-like carbon (DLC). DLC is superior in durability and corrosion resistance, and also superior in surface smoothness because it is amorphous. Therefore, DLC is used as a surface protective film of a magnetic recording medium. In the deposition of DLC performed by CVD (Chemical Vapor Deposition), DLC is generated by a chemical reaction by exciting and decomposing a source gas in a plasma. Therefore, it is possible to form DLC having a high sp³-bonded carbon ratio by adjusting the conditions.

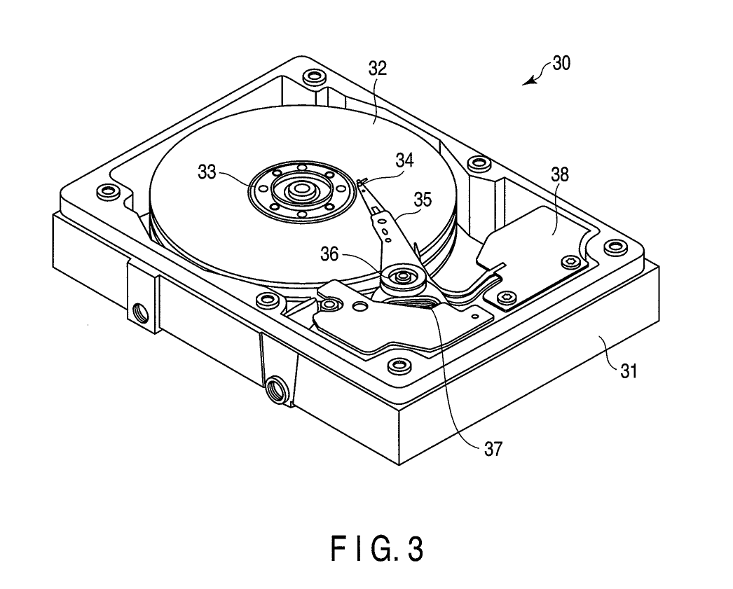

FIG. 3 is a partially exploded perspective view showing an example of the magnetic recording/reproduction apparatus according to the embodiment.

As shown in FIG. 3, a perpendicular magnetic recording apparatus 30 according to the embodiment includes a rectangular boxy housing 31 having an open upper end, and a top cover (not shown) that is screwed to the housing 31 by a plurality of screws and closes the upper-end opening of the housing.

The housing 31 accommodates, e.g., a perpendicular magnetic recording medium 32 according to the embodiment, a spindle motor 33 as a driving means for supporting and rotating the perpendicular magnetic recording medium 32, a magnetic head 34 for recording and reproducing magnetic signals with respect to the magnetic recording medium 32, a head actuator 35 that has a suspension on the distal end of which the magnetic head 34 is mounted, and supports the magnetic head 34 such that it freely moves with respect to the perpendicular magnetic recording medium 32, a rotating shaft 36 for rotatably supporting the head actuator 35, a voice coil motor 37 for rotating and positioning the head actuator 35 via the rotating shaft 36, and a head amplifier circuit 38.

### EXAMPLES

The embodiment will be explained in more detail below by way of its examples.

### Examples 1-6 & Comparative Examples 1-9

Implantation layers+implantation gases used in the examples were as follows.

Example 1: CeB₆ layer+Ar gas

Example 2: YB₆ layer+Ar gas

Example 3: LaB₆ layer+Ar gas

Example 4: CeB₆ layer+N₂ gas

Example 5: CeB₆ layer+HeN₂ gas

Example 6: Ce layer+B₂H₆ gas

Also, the condition of each comparative example was ion implantation alone, implantation layer+implantation gas not containing B, or B₂H₆ gas alone, as described below.

Comparative Examples 1 to 4: Ion implantation of (B, Y, La, or Ce) alone

Comparative Examples 5 to 8: Layer of (B, Y, La, or Ce)+Ar gas not containing B

Comparative Example 9: B₂H₆ gas alone

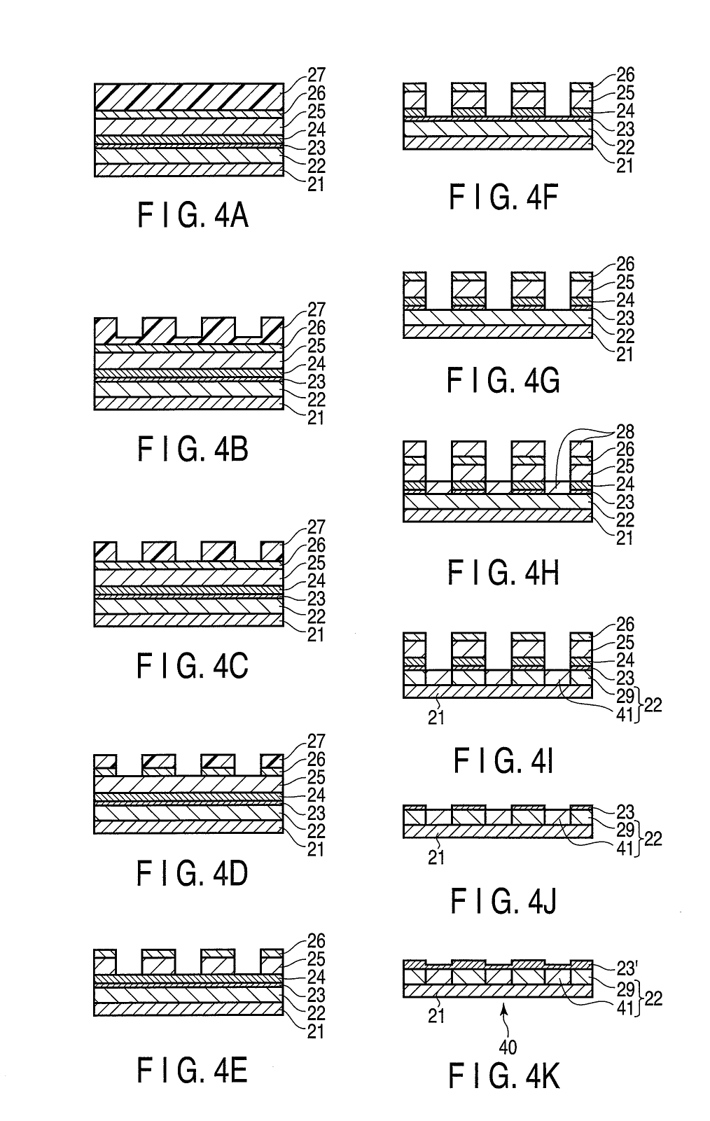

The manufacturing steps of a BPM according to Examples 1 to 6 will be explained below with reference to FIGS. 4A, 4B, 4C, 4D, 4E, 4F, 4G, 4H, 4I, 4J, and 4K.

FIGS. 4A, 4B, 4C, 4D, 4E, 4F, 4G, 4H, 4I, 4J, and 4K are views showing an example of a method of manufacturing the magnetic recording medium according to the embodiment.

A glass substrate 21 (amorphous substrate MEL6 available from KONICA MINOLTA, diameter=2.5 inches) was placed in a deposition chamber of a DC magnetron sputtering apparatus (C-3010 available from ANELVA), and the deposition chamber was evacuated to an ultimate vacuum degree of 1×10⁻⁵ Pa. On this substrate, 40-nm thick Co-7 at % Ta-5 at % Zr was deposited as a soft magnetic layer (not shown), thereby forming a soft magnetic backing layer. Then, 20-nm thick Ru as an interlayer (not shown) and 20-nm thick Co-20 at % Pt-10 at % Cr as a perpendicular magnetic recording layer 22 were formed. After that, a 4-nm thick DLC protective layer 23 was formed by CVD.

Subsequently, the BPM was manufactured as follows.

As shown in FIG. 4A, a 5-nm thick first hard mask 24 made of Mo, a 25-nm thick second hard mask 25 made of C, and a 3-nm thick third hard mask 26 made of Si were deposited. A resist 27 was formed on the third hard mask (Si) 26 by spin coating so as to have a thickness of 50 nm. Then, a stamper having predetermined three-dimensional patterns was prepared. This stamper was manufactured through EB lithography, Ni electroforming, and injection molding.

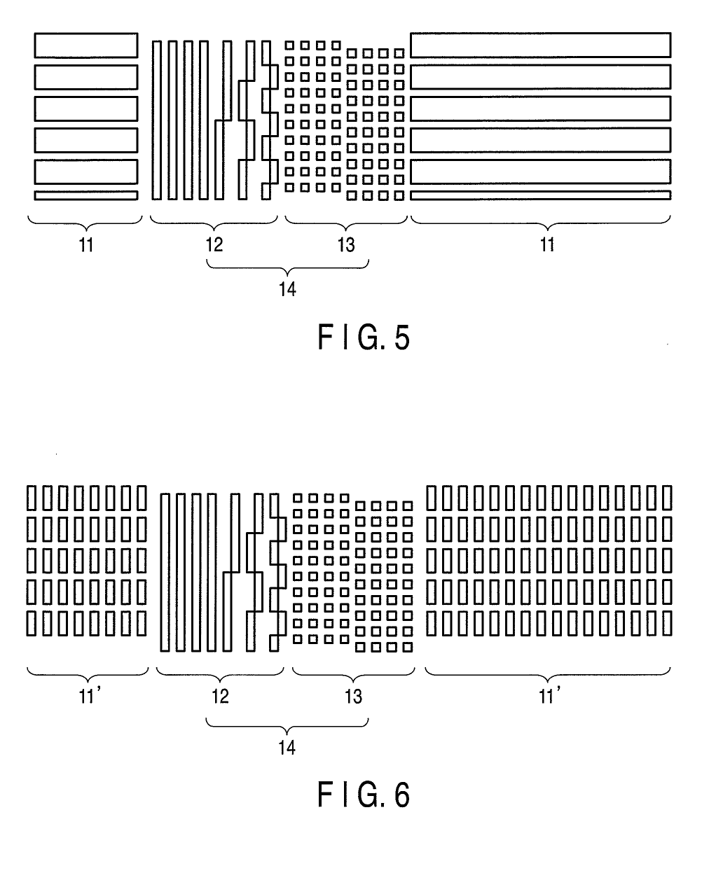

FIGS. 5 and 6 show examples of the above-mentioned, three-dimensional patterns. FIG. 5 is a front view showing examples of DTM three-dimensional patterns in which recording tracks and information for positioning a recording/reproduction head are recorded. FIG. 6 is a front view showing examples of BPM three-dimensional patterns in which recording bits and information for positioning a recording/reproduction head are recorded.

Examples of the above-mentioned EB lithography patterns are patterns corresponding to a track pattern 11 formed in a data area and a servo area pattern 14 formed in a servo area and including a preamble address pattern 12 and burst pattern 13, as shown in FIG. 5, or patterns corresponding to a bit pattern 11′ formed in the data area and the servo area pattern 14 formed in the servo area and including the preamble address pattern 12 and burst pattern 13, as shown in FIG. 6.

The stamper was set such that its three-dimensional surface faced the resist. As shown in FIG. 4B, the three-dimensional patterns of the stamper were transferred onto the resist 27 by imprinting the stamper on the resist. After that, the stamper was removed.

The resist residue remained on the bottoms of recesses of the three-dimensional patterns transferred onto the resist 27. Therefore, the resist residue in the recesses was removed by performing dry etching for an etching time of 60 sec by an inductively coupled plasma-reactive ion etching (ICP-RIE) apparatus by using CF₄ as a process gas at a chamber pressure of 0.1 Pa, a coil RF power of 100 W, and a platen (bias) RF power of 50 W. Consequently, the surface of the third hard mask (Si) 26 was exposed, as shown in FIG. 4C.

Then, the patterned resist 27 was used as a mask to perform ion beam etching for an etching time of 20 sec by the ICP-RIE apparatus by using CF₄ as a process gas at a chamber pressure of 0.1 Pa, a coil RF power of 100 W, and a platen RF power of 50 W. Consequently, as shown in FIG. 4D, the patterns were transferred onto the third hard mask (Si) 26, and the second hard mask (C) 25 was exposed in the recesses.

Subsequently, the patterned third hard mask (Si) 26 was used as a mask to etch the second hard mask made of C for an etching time of 20 sec by the ICP-RIE apparatus by using O₂ as a process gas at a chamber pressure of 0.1 Pa, a coil RF power of 100 W, and a platen RF power of 50 W. Consequently, as shown in FIG. 4E, the patterns of third hard mask (Si) 26 were transferred onto the second hard mask (C) 25, and the surface of the first hard mask (Mo) 24 was exposed in the recesses.

As shown in FIG. 4F, the patterned second hard mask (C) 25 was used as a mask to etch the first hard mask 24 made of Mo for an etching time of 10 sec by an ion milling apparatus by using Ar gas at a gas pressure of 0.06 Pa and an acceleration voltage of 400 V, thereby transferring the patterns onto the first hard mask 24, and exposing the surface of the DLC layer 23 in the recesses.

As shown in FIG. 4G, the patterned first hard mask (Mo) 24 was used as a mask to etch the DLC layer 23 for an etching time of 5 sec by the ICP-RIE apparatus by using O₂ as a process gas at a chamber pressure of 0.1 Pa, a coil RF power of 100 W, and a platen RF power of 50 W, thereby transferring the patterns onto the DLC layer 23, and exposing the surface of the magnetic recording layer 22 in the recesses.

Subsequently, non-recording portions were demagnetized as follows.

As shown in FIG. 4H, 10-nm thick cerium hexaboride was deposited as an implantation layer 28 on the magnetic recording layer 22 for a deposition time of 10 sec by performing DC sputtering using Ar gas at a chamber pressure of 0.7 Pa and a power of 500 W.

Then, as shown in FIG. 4I, cerium hexaboride was implanted in the magnetic recording layer for a processing time of 100 sec by an electron cyclotron resonance (ECR) ion gun by using Ar gas as an implantation gas at a gas pressure of 0.1 Pa, a microwave power of 1,000 W, and an application voltage of 5,000 V. In this manner, non-recording portions 29 and recording portions 41 were formed in the magnetic recording layer 22.

As shown in FIG. 4J, to remove all the layers remaining above the DLC protective layer 23, the medium was dipped in a hydrogen peroxide solution and held in it for 1 min, thereby removing the first hard mask (Mo) 24 and all the films deposited on it.

Finally, as shown in FIG. 4K, a DLC protective layer 23′ was formed by forming a 4-nm thick DLC protective layer on the DLC protective layer 23 by CVD, and coated with a lubricant (not shown) by dipping, thereby obtaining a patterned perpendicular magnetic recording medium 40 according to the embodiment.

Similarly, perpendicular magnetic recording media of Examples 2 to 6 and Comparative Examples 1 to 9 were obtained by using combinations described in Table 1 as implantation layers and implantation gases.

The recording/reproduction characteristic, static magnetic characteristic, and surface roughness of each of Examples 1 to 6 and Comparative Examples 1 to 9 were measured.

The recording/reproduction characteristic was evaluated by measuring the electromagnetic conversion characteristic by using read/write analyzer RWA1632 and spinstand S1701MP available from GUZIK, U.S.A. The recording/reproduction characteristic was evaluated by using a head including a shielded magnetic pole as a single pole having a shield (a shield has a function of converging a magnetic flux generated from a magnetic head) for write, and a TMR element as a reproduction unit. That is, the SNR of the head was measured at a linear recording density of 1,400 kBPI as a recording frequency condition.

The surface roughness was measured by using AFM available from Veeco. The measurement was performed in a visual field of 10 μm in a tapping mode at a resolution of 256×256.

Transmission electron microscope (TEM) observation in the substrate sectional direction and energy dispersive X-ray spectroscopy (TEM-EDX) measurement were performed on these media, thereby measuring the three-dimensional shape of the section and the light rare earth metal content of each medium.

In the media of Examples 1 to 6, no light rare earth metal was observed in the recording region. On the other hand, about 20 at % of the light rare earth metal were observed in the non-recording portions.

Also, to check magnetization corresponding to the non-recording portions, a medium (in which the entire surface was a non-recording portion) was separately manufactured by performing implantation in the entire surface of a magnetic recording layer without using any mask, and magnetization was measured. The static magnetic characteristic was evaluated by using a vibrating sample magnetometer (VSM) available from Riken Denshi.

When compared to the media of Comparative Examples 1 to 9, the media of Examples 1 to 6 each had a high SNR. Even when B or a light rare earth metal alone was ion-implanted as in the comparative examples, the non-recording portions were not sufficiently demagnetized. This is so probably because when using the ion implantation method, the distribution of ions implanted in a metal layer had a droplet shape, so diffusion in the surfacemost layer and lowermost layer was insufficient and magnetism remained. When diffusing a light rare earth metal alone by Ar, the effect of diffusion to the vicinity of the surface layer was large, but implantation to the lowermost layer was difficult. This presumably left magnetism behind in the lowermost layer.

On the other hand, in the medium according to the embodiment, as indicated by the examples, in addition to magnetism deactivation by the light rare earth metal element and boron, the generation of the boride destroyed the crystal lattices and increased the diffusion effect, and this presumably made it possible to sufficiently deactivate magnetism from the surfacemost layer to the lowermost layer. Consequently, in the media of Examples 1 to 6, the magnetization (Ms) in the non-recording portions was 0, so there was no magnetic interference between recording bits. On the other hand, in the media of Comparative Examples 1 to 9, Ms remained in the non-recording portions, and this probably caused magnetic interference between magnetic bits and increased noise. Furthermore, the media of Examples 1 to 6 each had surface roughness better than those of the media of Comparative Examples 1 to 9. Accordingly, the head floating characteristic perhaps improved as well.

TABLE 1

| | | | | Light rare | | | |
|---|---|---|---|---|---|---|---|
| | | | | earth content in | Ms in | | |
| | | Implantation | Implantation | non-recording | non-recording | SNR | Ra |
| | | layer | gas | portions (at %) | portions (emu/cc) | (dB) | (nm) |
| Example | 1 | CeB₆ | Ar | 20 | 0 | 13.7 | 0.4 |
| | 2 | YB₆ | Ar | 20 | 0 | 13.5 | 0.5 |
| | 3 | LaB₆ | Ar | 20 | 0 | 13.6 | 0.5 |
| | 4 | CeB₆ | N₂ | 20 | 0 | 14.2 | 0.3 |
| | 5 | CeB₆ | He—N₂ | 20 | 0 | 14.4 | 0.2 |
| | 6 | Ce | B₂H₆ | 20 | 0 | 12.3 | 0.5 |
| Comparative | 1 | B | (Ion | 20 | 230 | 9.5 | 1.6 |
| Example | | | implantation) | | | | |
| | 2 | Ce | (Ion | 20 | 110 | 9.8 | 1.5 |
| | | | implantation) | | | | |
| | 3 | Y | (Ion | 20 | 130 | 6.5 | 1.7 |
| | | | implantation) | | | | |
| | 4 | La | (Ion | 20 | 120 | 8.8 | 1.4 |
| | | | implantation) | | | | |
| | 5 | B | Ar | 20 | 280 | 9.0 | 1.2 |
| | 6 | Ce | Ar | 20 | 220 | 6.3 | 1.4 |
| | 7 | Y | Ar | 20 | 250 | 6.3 | 1.4 |
| | 8 | La | Ar | 20 | 230 | 9.1 | 1.8 |
| | 9 | — | B₂H₆ | 20 | 200 | 9.1 | 1.1 |

Note that about Ms: to check magnetization corresponding to the non-recording portions, a medium (in which the entire surface was a non-recording portion) was manufactured by performing implantation in the entire surface of a magnetic recording layer without using any mask, and magnetization was measured.

Note also that the three mask layers were formed in Example 1 described above, but the embodiment is not limited to this, and it is also possible to form one mask layer.

An example in which one mask layer is formed will be described below.

A resist is formed on a DLC protective layer by spin coating so as to have a thickness of 50 nm. Then, a stamper having predetermined three-dimensional patterns is prepared. This stamper is manufactured through EB lithography, Ni electroforming, and injection molding. The stamper is set such that its three-dimensional surface faces the resist. The three-dimensional patterns of the stamper are transferred onto the resist by imprinting the stamper on the resist. After that, the stamper is removed. The resist residue remains on the bottoms of recesses of the three-dimensional patterns transferred onto the resist. Therefore, dry etching is performed for an etching time of 60 sec by the ICP-RIE apparatus by using CF₄ as a process gas at a chamber pressure of 0.1 Pa, a coil RF power of 100 W, and a platen (bias) RF power of 50 W, thereby removing the resist residue in the recesses, and exposing the surface of the DLC protective layer. Then, the patterned resist is used as a mask to etch the DLC layer for an etching time of 5 sec by the ICP-RIE apparatus by using O₂ as a process gas at a chamber pressure of 0.1 Pa, a coil RF power of 100 W, and a platen RF power of 50 W, thereby transferring the patterns onto the DLC layer, and exposing the surface of the magnetic recording layer in the recesses.

### Examples 7-11

Combinations of light rare earth metal layers/B layers+implantation gases used in the Examples 7 to 11 were as follows.

Example 7: Y layer/B layer+Ar gas

Example 8: La layer/B layer+Ar gas

Example 9: Ce layer/B layer+Ar gas

Example 10: Ce layer/B layer+N₂ gas

Example 11: Ce layer/B layer+HeN₂ gas

Perpendicular magnetic recording media of Examples 7 to 11 were manufactured as follows.

The perpendicular magnetic recording media of Examples 7 to 11 were obtained following the same procedures as in Example 1 except that after the surface of a magnetic recording layer was exposed in recesses by etching a patterned mask, a 5-nm thick cerium film was deposited as a first implantation layer on the magnetic recording layer for a deposition time of 5 sec by performing DC sputtering using Ar gas at a chamber pressure of 0.7 Pa and a power of 500 W, and a 5-nm thick B film was deposited as a second implantation layer for a deposition time of 10 sec by performing RF sputtering using Ar gas at a chamber pressure of 0.7 Pa and a power of 500 W, thereby forming two implantation layers, i.e., the light rare earth metal layer and B layer, and that implantation gas species were changed as shown in Table 2.

TEM and TEM-EDX measurements were performed on these media in the same manner as in Example 1, thereby measuring the light rare earth metal contents of the media. Consequently, no light rare earth metal was observed in the recording region of any of the media of Examples 7 to 11. On the other hand, about 20 at % of the light rare earth metal were observed in the non-recording portions.

The recording/reproduction characteristic, static magnetic characteristic, and surface roughness of each of these media were measured in the same manner as in Example 1. As shown in Table 2, the media of Examples 7 to 11 each had a high SNR. That is, since the light rare earth metal layer and B layer were stacked and diffused by Ar ions, the light rare earth metal and B formed a light rare earth boride in the non-recording portions, and their synergistic effect presumably demagnetized the non-recording portions. This probably eliminated magnetic interference between magnetic bits, and improved the characteristics. In addition, the media of Examples 7 to 11 each had surface roughness better than those of the media of the comparative examples. This perhaps improved the head floating characteristic as well.

TABLE 2

| | | | | Light rare | | | |
|---|---|---|---|---|---|---|---|
| | | | | earth content in | Ms in | | |
| | | Implantation | Implantation | non-recording | non-recording | SNR | Ra |
| | | layer | gas | portions (at %) | portions (emu/cc) | (dB) | (nm) |
| Example | 7 | Ce/B | Ar | 20 | 0 | 12.3 | 0.4 |
| | 8 | Y/B | Ar | 20 | 0 | 12.2 | 0.5 |
| | 9 | La/B | Ar | 20 | 0 | 12.1 | 0.5 |
| | 10 | Ce/B | N₂ | 20 | 0 | 12.5 | 0.4 |
| | 11 | Ce/B | HeN₂ | 20 | 0 | 12.9 | 0.3 |

Note that about Ms: to check magnetization corresponding to the non-recording portions, a medium (in which the entire surface was a non-recording portion) was manufactured by performing implantation in the entire surface of a magnetic recording layer without using any mask, and magnetization was measured.

### Examples 12-17 & Comparative Examples 10 & 11

Combinations of light rare earth metal with B layers+Ar gas used in Examples 12 to 17 and Comparative Examples 10 and 11 were as follows.

Example 12: CeB₆ layer+Ar gas

Example 13: CeB₆ layer+Ar gas

Example 14: CeB₆ layer+Ar gas

Example 15: CeB₆ layer+Ar gas

Comparative Example 10: CeB₆ layer+Ar gas

Comparative Example 11: CeB₆ layer+Ar gas

Example 16: YB₆ layer+Ar gas

Example 17: LaB₆ layer+Ar gas

Perpendicular magnetic recording media of Examples 12 to 17 and Comparative Examples 10 and 11 were manufactured as follows. The perpendicular magnetic recording media of Examples 12 to 17 and Comparative Examples 10 and 11 were obtained following the same procedures as in Example 1 except that a perpendicular magnetic recording layer containing a light rare earth metal as shown in Table 3 was used instead of forming 20-nm thick Co-20 at % Pt-10 at % Cr, that an implantation layer containing the same element as the light rare earth element contained in the perpendicular magnetic recording layer was used, and that the light rare earth concentration in the non-recording portions was changed from 5 to 30 at % by using Ar gas as an implantation gas and changing the gas pressure and implantation time.

TABLE 3

| | | | | Light rare | Light rare | | |
|---|---|---|---|---|---|---|---|
| | | Perpendicular | | earth content in | earth content in | Ms in | |
| | | magnetic | Implantation | recording | non-recording | non-recording | SNR |
| | | recording layer | layer | portions (at %) | portions (at %) | portions (emu/cc) | (dB) |
| Example | 12 | Co—20%Pt—5%Cr—5%Ce | CeB₆ | 5 | 30 | 0 | 12.6 |
| | 13 | Co—20%Pt—5%Cr—5%Ce | CeB₆ | 5 | 25 | 0 | 12.4 |
| | 14 | Co—20%Pt—5%Cr—5%Ce | CeB₆ | 5 | 20 | 0 | 12.3 |
| | 15 | Co—20%Pt—5%Cr—5%Ce | CeB₆ | 5 | 15 | 0 | 12.0 |
| Comparative | 10 | Co—20%Pt—5%Cr—5%Ce | CeB₆ | 5 | 10 | 100 | 8.3 |
| Example | 11 | Co—20%Pt—5%Cr—5%Ce | CeB6 | 5 | 5 | 110 | 7.8 |
| Example | 16 | Co—20%Pt—5%Cr—5%Y | YB6 | 5 | 20 | 0 | 12.5 |
| | 17 | Co—20%Pt—5%Cr—5%La | LaB6 | 5 | 20 | 0 | 12.2 |

Note that about Ms: to check magnetization corresponding to the non-recording portions, a medium (in which the entire surface was a non-recording portion) was manufactured by performing implantation in the entire surface of a magnetic recording layer without using any mask, and magnetization was measured.

TEM and TEM-EDX measurements were performed on these media in the same manner as in Example 1, thereby measuring the light rare earth metal contents of the media. Consequently, the light rare earth metal was observed at a concentration of 5 at % in the recording region of each of the media of Examples 12 to 17 and Comparative Examples 10 and 11. On the other hand, 5 to 30 at % of the light rare earth metal were observed in the non-recording region.

The recording/reproduction characteristics and static magnetic characteristics of these media were measured. As shown in Table 3, the media of Examples 12 to 17 each had a higher SNR than those of the media of Comparative Examples 10 and 11. That is, since the light rare earth metal concentration in the non-recording portions was higher by 10 at % or more than that in the recording region, it was possible to demagnetize the non-recording portions. This probably eliminated magnetic interference between magnetic bits, and improved the characteristics.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A magnetic recording medium comprising:
a substrate; and
a magnetic recording layer on the substrate, the magnetic recording layer comprising:
recording portions having patterns regularly arranged in a longitudinal direction, the recording portions comprising cobalt and platinum; and
non-recording portions between the recording portions, the non-recording portions comprising boron and at least one light rare earth metal selected from the group consisting of yttrium, lanthanum, and cerium.

2. The medium of claim 1, wherein the non-recording portions comprise at least 10 at % more of the light rare earth metal than do the recording portions.

3. A magnetic recording medium manufacturing method comprising:
forming a mask layer, having regularly arranged patterns, on a magnetic recording layer on a substrate, the magnetic recording layer comprising cobalt and platinum;
forming, using the mask layer, an implantation layer comprising at least one light rare earth metal selected from the group consisting of yttrium, lanthanum, and cerium; and
demagnetizing, in a thickness direction, the magnetic recording layer in a region not covered with the mask layer by performing gas ion irradiation on the implantation layer by using an implantation gas, thereby forming recording portions having regularly arranged patterns, and forming non-recording portions between the recording portions,
wherein at least one of the implantation layer and the implantation gas comprise boron.

4. The method according to claim 3, wherein the implantation layer comprises a boride of at least one light rare earth metal selected from the group consisting of yttrium, lanthanum, and cerium.

5. The method according to claim 3, wherein the implantation layer comprises a multilayered film comprising a boron layer and a layer containing at least one light rare earth metal selected from the group consisting of yttrium, lanthanum, and cerium.

6. The method according to claim 3, wherein the implantation layer comprises at least one light rare earth metal selected from the group consisting of yttrium, lanthanum, and cerium, and wherein the implantation gas comprises boron.

7. A magnetic recording/reproduction apparatus comprising:
a perpendicular magnetic recording medium comprising:
a substrate; and
a magnetic recording layer on the substrate, the magnetic recording layer comprising:
recording portions having patterns regularly arranged in a longitudinal direction, the recording portions comprising cobalt and platinum; and
non-recording portions between the recording portions, the non-recording portions comprising boron and at least one light rare earth metal selected from the group consisting of yttrium, lanthanum, and cerium;
a rotatable support configured to support and rotate the perpendicular magnetic recording medium;
a magnetic head comprising a first element configured to record information on the perpendicular magnetic recording medium, and a second element configured to reproduce recorded information; and
a carriage assembly configured to support the magnetic head such that the magnetic head freely moves with respect to the perpendicular magnetic recording medium.

8. The apparatus of claim 7, wherein the non-recording portions comprise at least 10 at % more of the light rare earth metal than do the recording portions.
